(19) United States
(12) Patent Application Publication
(10) Pub. No.: US 2007/0271454 A1
(43) Pub. Date: Nov. 22, 2007

(54) Network communication device security system and method of the same

(75) Inventors: Shin-Pin Yen, Tainan City (TW); Hsiang-Wen Yang, Tainan City (TW); Wen-Yen Chen, Chiayi City (TW)

Correspondence Address: BIRCH STEWART KOLASCH & BIRCH, PO BOX 747, FALLS CHURCH, VA, 22040-0747, US

(73) Assignee: Accton Technology Corporation

(21) Appl. No.: 11/802,195

(22) Filed: May 21, 2007

(30) Foreign Application Priority Data
May 22, 2006 (TW) 095118173

(51) Int. Cl. H04L 9/00

(52) U.S. Cl. 713/153

(57) ABSTRACT

The present invention discloses a security system. The security system comprises an image capturing device, a network communication device coupled to a user terminal via Internet. The present invention includes a network communication device having one or more external device connecting ports and at least one network port, an image capturing device is coupled to the USB port of the network communication device or builds in the network communication device. The image capturing device is controller by the network communication device to detect the environment image. The detected result will be informed to a user terminal or be stored in a memory. The image capturing device is controlled by the network communication device, and catches a reference image, then the network communication device catches subsequent image for comparing with the reference image. If the difference between the subsequent image and the reference image is over a threshold value, then the network communication device will send a signal to a determined IP address or send the signal to a determined mobile number or the like.

### FIELD OF THE INVENTION

The present invention relates to a security system, in particular, a security system associated with the network communication device.

### BACKGROUND OF THE INVENTION

The development and fast-growing of Internet is one of the most important achievements in modern technology. The main goal of Internet development is for information exchanging. Traditionally, people had to communicate with each other by letters or telephone calls. But now, by means of Internet development, a variety of communicate way are provided, for example, electronic mail, Bulletin Board System (BBS), and Internet bulletin board, etc. Therefore, the exchange of information becomes more intense and effective.

Nowadays, more new technology is applied in new ways upon Internet. For instance, by means of real-time web chat, real-time delivery of image and voice, the manner of information exchange is totally changed. In addition, the rise of wireless network also widens the scope of Internet application. No matter in business, in industry, in medical or military aspects, it is rapidly developing because of integrating with Internet.

In the past, Internet-based instant messaging, for example, MSN, web chat, was merely able to deliver the text message. With widening the bandwidth of network, it is possible to deliver image in real-time, for instance, catch image by the image capturing device/network camera and send it by the real-time chat software.

Furthermore, the image capturing device/network camera can be used as a security monitor to take the place of a traditional monitor or video camera. It not only reduces cost of the security system and component efficiently, but also makes possible to apply the security system in more field. The security system controlled by computer is for the purpose of substituting the traditional human monitor and the computer which connects to Internet is able to broaden the scope of the security system applications.

However, the security system has to be established by computer and Internet, and it has higher cost because the mainframe computers are huge, heavy, and expensive. Moreover, it is necessary to boot the computer during the system operation. As we know, the computer takes so long to start up, and it can not be utilized at will. In sum, a new security system is required to overcome the shortcomings of the prior arts.

### SUMMARY OF THE INVENTION

In view of these problems of prior arts, we present the invention for the purpose of providing a security system for network communication device. The advantage of the present invention is that simple components of it provide easy assembly convenience and efficiently reducing the cost of security system. In addition, the present invention can transmit information through Internet and efficiently deliver the signal from the security system to default IP address or phone number of remote terminal so that the remote terminal user can receive the signal from security system immediately. The information can be in the form of either a text message, an electronic mail, MSN, a traditional phone, an Internet Protocol phone, or image data. That is to say, it also can be the pictured or photographed data stored in local or remote terminal hard disk by user.

Furthermore, another advantage of the present invention is that the image capturing device/network camera controlled by network communication device can avoid the inconvenience resulting from manual operation or human monitor of traditional security system. Hence, the security system disclosed in the present invention provides a much better and more flexible way to set up, and also broadens the scope of application of security system.

The present invention discloses a security system, comprising a network communication device with one or more external device connecting ports and one or more network ports; an image capturing device connected to the external device connecting ports of the network communication device, coupled to the network communication device, and controls the image capturing device to catch images via the network communication device. It also includes a user terminal which controls the network communication device and image capturing device.

In addition, in another aspect, the present invention discloses a method for performing a security system which utilizing a network communication device to control an image capturing device for catching images. The method includes following steps: catching an image as a reference image; catching another image as a subsequent image; comparing the subsequent image with the reference image; transmitting a signal to user terminal through Internet upon the comparison result.

### BRIEF DESCRIPTION OF THE DRAWINGS

FIG. 1 is a diagram of the security system of the present invention.

FIG. 2 is a structural diagram showing a network communication device of one preferred embodiment of the present invention.

FIG. 3 is a flow diagram illustrating the method for performing a security system in accordance with the present invention.

### DETAILED DESCRIPTION OF THE PREFERRED EMBODIMENT

Presently, it will describe some preferred embodiments, however, the ensuing detailed description provides preferred exemplary embodiments only, and is not intended to limit the scope, applicability, or configuration of the invention. It should be recognized that the present invention can be practiced in a wide range of other embodiments besides those explicitly described, and the scope of the present invention is not limited by any embodiments. It should be defined by the appended claims. Furthermore, the different parts of components are not displayed to the proportion. For a clear description and understanding of the present invention, the relating elements have been displayed in enlarged form, and the irrelevant parts are not shown. Although, an individual gateway is used as an illustration of a network communication device of one preferred embodiment, it will be obvious to those skilled in the art that the network communication device can also be a wireless access point, a bridge, etc.

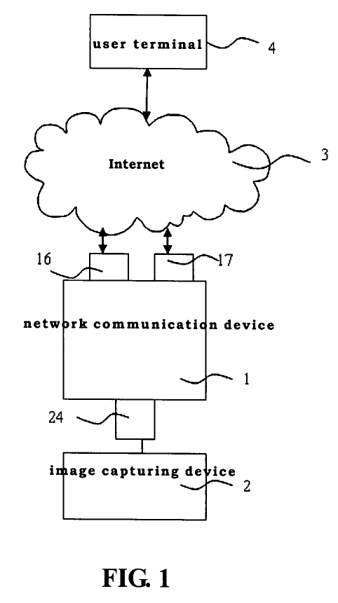

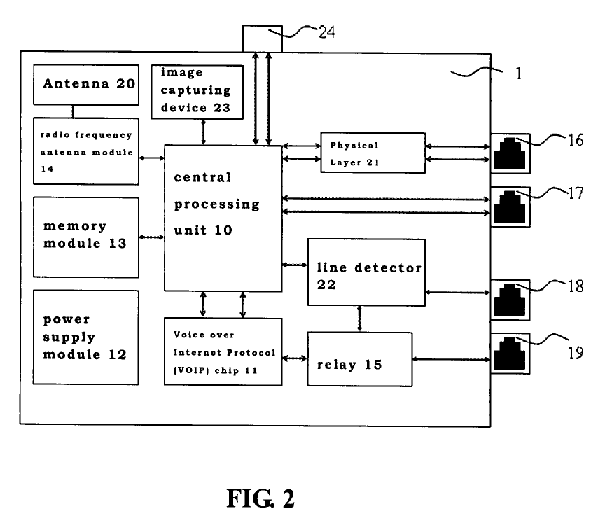

FIG. 1 shows that a security system of the present invention, comprising a network communication device 1 described as an example here is a personal gateway. However, it is not limited by the device mentioned above. By means of Internet 3, the foregoing network communication device 1 may connect to a user terminal 4. The foregoing network communication device 1 includes one or more network connecting ports, for instance, a local area network (LAN) port with RJ45 connector 16 or/and a wide area network (WAN) port with RJ45 connector 17, and plural external device connecting ports. In the meantime, please refer to the USB port 24 and the FXS port 19 shown in FIG. 1 and FIG. 2. The image capturing device 2 is able to either connect through USB port 24 to the network communication device 1, or be inside set up in embedded CCD line of the personal gateway; that is to say, it can directly couples to the network communication device 1. Moreover, the network communication device 1 described in the present preferred embodiment further comprises a FXO port 18 and a FXS port 19 for connecting to a regular phone, a mobile phone or an Internet Protocol phone. Also, the network communication device 1 described in the present preferred embodiment is able to connect to the user terminal 4 via a regular phone, a mobile phone or an Internet Protocol phone. The network communication device 1 can connect through the local area network (LAN) port 16 and the wide area network (WAN) port 17 to Internet 3. In addition, the network communication device 1 described in the present preferred embodiment is able to wirelessly connect to the user terminal 4 by means of the radio frequency antenna module 14 and the antenna 20. Usually, the user terminal 4 is either a hardware device with default IP address, PSTN telephone number, or cell phone number. It is able to communicate with the specific Internet Protocol phone from the foregoing IP address.

In one embodiment, the image capturing device 2 includes a network camera (CCD camera or CMOS camera) that connects to the USB port of the foregoing network communication device 1 in order to catch the surrounding images. Furthermore, the above-mentioned network camera can also be embedded in the network communication device 1. Consequently, the present invention controls the image capturing device 2 for catching the images via the network communication device 1. For ease consideration, the image capturing device 2 can be set up in any position where is able to connect with the network communication device 1 for the purpose of operating the security system without manually controlling, monitoring, or detecting. The monitoring or detection comprises photographing, photo shooting, continuous picturing, real-time monitoring, etc. Furthermore, the sequences of the present invention includes: Initially, the foregoing network communication device 1 catches a reference image, followed by catching a subsequent image, subsequently. After both images are taken, the devise compares the subsequent image with the reference image. As the difference between both images exceeds a threshold value, the network communication device 1 will send a signal to inform the abnormal situation to the user. That is to say, the signal will be transmitted through Internet 3 to the user terminal 4. The user terminal, for instance, includes the hardware device with default IP address or cell phone number. The above-mentioned transmitted signal includes, but not be limited to, an image, a voice message, a text message, an electronic mail, a traditional PSTN phone call, an Internet Protocol phone call, a MSN message, a voice message for mobile phone, or image data. In the same way, it also can be the pictured or photographed data stored in local or remote terminal hard disk by the user. Base on the requirement of image comparison, the foregoing network communication device comprises an image comparison module to store the image difference in the memory module.

FIG. 2 illustrates a functional diagram according to one embodiment of the present invention, it comprises the central processing unit 10, the Voice over Internet Protocol (VOIP) chip 11, the power supply module 12, memory module 13, the radio frequency antenna module 14, the antenna 20, the Physical Layer 21, the line detector 22, the relay 15, the image comparison module 23, the local area network (LAN) port with RJ45 connector 16, the wide area network (WAN) port with RJ45 connector 17, and the USB port 24 for connecting the network camera; in addition, it also comprises the FXO port with RJ-11 connector 18 and the FXS port with RJ-11 connector 19. The detailed will be described as below.

The central processing unit 10 is employed as the central control for the processing of data and acts as the medium access controller for IEEE 802.11a/b/g wireless local area network (WLAN) and the baseband processor. The wide area network (WAN) port 17 connects to the central processing unit 10 and the local area network (LAN) port 16 connects to the central processing unit 10 via the Physical Layer 21. The central processing unit 10 may connect to Internet 3 by means of the local area network (LAN) port 16 and the wide area network (WAN) port 17 for external communication and data transfer. The port 16 and port 17 may be provided with the RJ45 connector in order to connect to the Ethernet. The wide area network (WAN) port 17 conforms to the Media Access Control (MAC) specification of IEEE 802.3 Fast Ethernet standard. The local area network (LAN) port 16 of the network communication device 1 connects to 10/100 MHZ Physical Layer (PHY) 21, and might be provided with the Media Access Control (MAC) of IEEE 802.3 Fast Ethernet and reverse media independent interface (reverse MII interface). The wide area network (WAN) port 17 is compatible with the specification of embedded IEEE 802.11a/b/g wireless network, and the port of the present device is characterized by the Ethernet auto-sensing function. The foregoing FXO port 18 and FXS port 19 may be provided with RJ11 connector, and be employed to reach the user terminal 4 by connecting to a general PSTN telephone, a mobile phone, or an Internet Protocol phone.

The radio frequency antenna module 14, which connects to the central processing unit 10, is used to process the radio frequency signal, and transmit the radio frequency signal by the antenna 20 for wireless communication. The radio frequency antenna module 14 coupled to the antenna 20 is provided with a radio frequency (RF) interface chip for facilitating the 802.11b/g wireless local area network. The aforementioned device is described only for illustration rather than limiting the scope, applicability of the present invention.

The relay 15 connects via the Voice over Internet Protocol (VOIP) chip 11 to the central processing unit 10. It also connects to the FXS port 19 and the FXO port 18 by the line detector 22. The relay 15 receives the signal via the FXS port 19 or the FXO port 18 by means of switching the FXS port 19 or the FXO port 18. The line detector 22 is provided between the FXO port 18 and the relay 15 and it is controlled by the central processing unit 10 for detecting the line connection status of the FXO port 18. Upon the detected result of the line detector 22, the relay 15 will be switched between the FXO port 18 and the FXS port 19.

In one embodiment, the present invention includes an image comparison module (that is) coupled to the central processing unit 10 for comparing image data. The image data may be stored in memory module 13 or any other exterior memory device.

The Voice over Internet Protocol (VOIP) chip 11 connected to the central processing unit 10 is used to process the signal from the Internet Protocol phone compatible with Voice over Internet Protocol (VOIP). The FXO port 18 and the FXS port 19 couples to the central processing unit 10 via the relay 15 and the Voice over Internet Protocol (VOIP) chip 11. The network communication device 1 is also provided with the programmable SPI interface and the PCM interface supporting 64 channel systems for connecting to the Voice over Internet Protocol (VOIP) chip 11 as an Internet Protocol phone. Hence, the foregoing network communication device 1 may transmit the signal through the Internet Protocol phone.

The memory module 13 mentioned above may be used to store the exterior image data or associated operating system, program, or instruction. The memory module 13 includes Synchronous Dynamic Random Access Memory (SDRAM) or Flash memory to store the reference image and the subsequent image caught by the image capturing device 2 for comparing the images. The above-mentioned parameter is described only for illustration, but not to limit the scope, applicability of the present invention.

The power supply module 12 is provided to transform the exterior power into direct current for network communication device. It comprises the embedded current reversal/double rectifier for providing adequate power necessary for each component contain therein. In addition, it is also provided with a low dropout voltage (LDO) regulator for supplying stable power to the radio frequency antenna module 14 and the central processing unit 10.

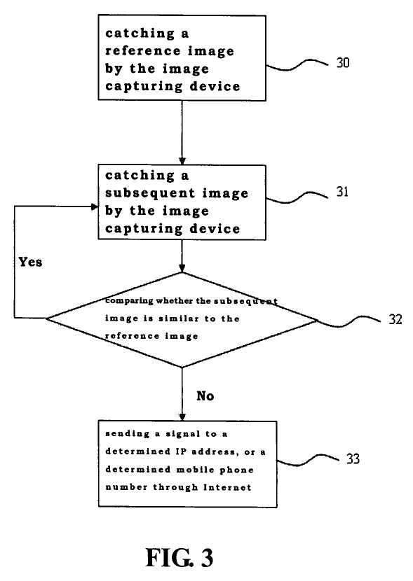

Refer to FIG. 3 which illustrates the flow diagram of the method for performing a security system in accordance with the present invention.

First, the image capturing device 2 is utilized to catch a peripheral image as a reference image, as shown in step 30. The foregoing reference image data could be encoded and compressed by the central processing unit, and then stored in the memory module 13. Subsequently, a subsequent image would be caught by the image capturing device as shown in step 31. The foregoing subsequent image data may be encoded and compressed, and then stored in the memory module 13.

Next, the subsequent image caught in step 31 and the reference image caught in step 30 could be compared to obtain the comparison result (difference) associated with the image caught in step 31, as shown in step 32. The foregoing image comparison is performed by the image comparison module 23 in the network communication device 1. If the difference between the subsequent image and the reference image exceeds a default threshold value, the central processing unit 10 will produce a signal, and connect to Internet 3 through the port of the wireless network module or the wired network module, and then send the foregoing signal to a determined IP address, or send the foregoing signal to a determined device, as shown in step 33. The wireless network module connects to Internet 3 through the radio frequency antenna module 14 and the antenna 20. Besides, the wired network module connects to Internet 3 via the local area network (LAN) port 16 and the wide area network (WAN) port 17. If the difference between the subsequent image and the reference image is not beyond the threshold value, it will return to step 31 to catch another subsequent image. Hence, the system could be continuously and automatically operated without manually monitoring. As mentioned above, the subsequent process of the detection described in the foregoing embodiment is based on whether the compared difference exceeds the threshold value. However, other mode of detection may be alternatively utilized, for instance, photographing, picturing, continuous picturing or real-time monitoring, etc.

In sum, the present invention provides a security system for network communication device. The above-mentioned image capturing device/network camera is used to catch the peripheral images. The security system could transmit a warming signal through Internet, or deliver to a phone for the purpose of enabling the remote user to receive the signal sent by the security system, and approaching the function of efficient security announcement. The security system of the present invention which is controlled by the network communication device is an unmanned security monitoring system. Furthermore, the components of the security system are simple and easy to use. It replaces the network communication device with the computer as a controller, and that will efficiently reduce the cost of the security system.

Although the preferred embodiments have been illustrated and described above, it is not intended to limit the scope, applicability, or configuration of the present invention. The present invention should be defined by the appended claims and the related technical field. It will be obvious to those skilled in the art that various modifications may be made without departing from what is intended to be limited solely by the appended claims.

What is claimed is:

1. A security system, comprising:
a network communication device including one or more external device connecting ports and one or more network ports; and
an image capturing device coupled to said external device connecting ports and controlled by said network communication device for detection;
wherein a result detected by said network communication device is stored or informed to a user terminal through an Internet.

2. The security system of claim 1, wherein said network communication device includes:
a central processing unit coupled to Internet via Physical Layer;
an Internet Protocol phone chip coupled to said central processing unit for processing Voice over Internet Protocol (VOIP) and signals;
a memory module coupled to said central processing unit, for storing image data;
a radio frequency antenna module coupled to said central processing unit, for processing radio frequency signal;
an antenna coupled to said radio frequency antenna module, for emitting radio frequency signal;
a line detector coupled to said central processing unit for detecting a line status of said external device connecting ports;
an image comparison module coupled to said central processing unit for comparing difference of images caught by said image capturing device, and sending a signal to said user terminal as said difference exceeds a threshold value;
a relay coupled to said central processing unit via said Internet Protocol phone chip for switching acts between said external device connecting ports upon said detected result of said line detector;
a power supply module for providing power.

3. The security system of claim 2, wherein said memory module includes Synchronous Dynamic Random Access Memory (SDRAM) and Flash memory.

4. The security system of claim 2, wherein said relay is used to switch actions between said external device connecting ports.

5. The security system of claim 1, wherein said detection includes picturing photographing real-time monitoring and continuous picturing.

6. The security system of claim 1, wherein said network communication device includes a personal gateway, a bridge, or an access point.

7. The security system of claim 1, wherein said external device connecting ports include a USB port.

8. The security system of claim 1, wherein said image capturing device is a network camera.

9. A method for performing a security system, said method comprising:
providing a network communication device for controlling an image capturing device to perform detection for catching image data and generating a message; and
transmitting said signal through a network to a user terminal or storing said image data.

10. The method of claim 9, wherein said detection comprising:
catching an image as a reference image;
catching another image as a subsequent image;
comparing said subsequent image with said reference image to obtain a comparison result associated with said message.

11. The method of claim 9, wherein said detection includes picturing, [symbol] photographing, [symbol] continuous picturing, [symbol] and real-time monitoring.

12. The method of claim 9, wherein said network communication device includes an image comparison module for comparing said image data.

13. The method of claim 9, wherein said user terminal includes a terminal device with a determined IP address.

14. The method of claim 9, wherein said user terminal includes a terminal device with a determined mobile number.

15. The method of claim 9, wherein said network communication device includes an Internet Protocol phone chip compatible with Voice over Internet Protocol (VOIP).

16. The method of claim 9, wherein said network communication device includes a personal gateway, a bridge, or an access point.

17. The method of claim 9, wherein said image capturing device is a network camera.
